(19) United States
(12) Patent Application Publication
(10) Pub. No.: US 2001/0005267 A1
(43) Pub. Date: Jun. 28, 2001

(54) Facsimile machine

(75) Inventor: Yoshifumi Tanimoto, Uji-shi (JP)

Correspondence Address: Hogan & Hartson L.L.P., Suite 1900, 500 South Grand Avenue, Los Angeles, CA, 90071, US

(73) Assignee: MURATA KIKAI KABUSHIKI KAISHA

(21) Appl. No.: 09/733,230

(22) Filed: Dec. 8, 2000

(30) Foreign Application Priority Data
Dec. 24, 1999 (JP) 11-368460

(51) Int. Cl. B41B 1/00

(52) U.S. Cl. 358/1.9; 358/444

(57) ABSTRACT

A facsimile machine adapted to receive data from a remote device (data transmitter) over LAN and transfer the data to a recipient over LAN or PSTN. A memory of the facsimile machine stores delivery conditions such as e-mail address of registered recipients and delivery day and time. A controller determines whether a request for data transfer from the data transmitter should be accepted, based on an address of the data transmitter and the registered e-mail addresses if the data transfer request is attached to the received data. If no data transfer request is attached, the controller determines whether the data should be transferred depending upon a current time and the registered day and time. In the latter case, the data transmitter does not have to append the data transfer request and recipient information to the data. Instead, the controller finds out an appropriate recipient in the delivery condition table.

### CROSS REFERENCE TO RELATED APPLICATIONS

This application claims priority of Japanese Patent Application No. 11-368460 filed in JPO on Dec. 24, 1999 under 35 USC 119, and the entire disclosure of this Japanese application is incorporated herein by reference.

### BACKGROUND OF THE INVENTION

1. Field of the Invention

The present invention relates to facsimile machines connectable to PSTN (Public Switched Telephone Network) and other networks such as LAN and internet.

2. Description of the Related Art

Recently, facsimile machines that are connectable to not only PSTN but also other networks such as LAN are being developed. Such facsimile machines can perform ordinary facsimile communication over PSTN, which receives and sends data from and to a remote device over PSTN, and another type of facsimile transmission, which receives data from a client machine connected to LAN and transmits it to a recipient over PSTN. This facsimile machine is also capable of receiving facsimile data from a remote machine over PSTN and transferring it to a client on LAN.

When a conventional facsimile machine receives image data from a remote machine (transmitting party) over LAN and transfers it to another device, it also obtains delivery information/instructions from the transmitting party. According to this delivery information/instructions, the facsimile machine transmits the data to a designated recipient. If the data transfer takes place over PSTN, a telephone fee needed to transfer the data is generally born by the transmitting party.

A facsimile machine often receives a data transfer request from an unexpected party since the networks such as LAN have developed and wide spread and many facsimile machines are connected to LAN. It also receives a data transfer request from another section or department of a company. In such case, the telephone fee is not charged to a data transmitting party, but the facsimile machine. A user of the facsimile machine does not want to bear the data transfer expense. Further, it is unpleasant to have its own facsimile machine used by unknown or unexpected parties. However, the conventional facsimile machine has no measures to these problems.

The data transmitting party should attach the recipient information to the image data when it requests the data transfer to the facsimile machine. For example, if the transmitting party wants to send facsimile data to a number of recipients via the facsimile machine, it should specify telephone numbers of all the recipients each time. This is troublesome.

### SUMMARY OF THE INVENTION

An object of the present invention is to provide a facsimile machine that can prevent misuse of a data transfer function of the facsimile machine by a third party.

Another object of the present invention is to provide a facsimile machine that can improve a data transfer function.

According to one aspect of the present invention, there is provided a facsimile machine connectable to PSTN and another network and adapted to receive data from a data transmitter over said another network and transfer the data to a recipient, including a memory for storing transfer conditions, such as whether or not a request for data transfer should be accepted, in accordance with at least part of an address of the data transmitter, and a controller for determining whether the request for data transfer should be accepted, based on the address of the data transmitter and the transfer conditions. When the facsimile machine receives a request for data transfer from a stranger, it refuses such request. Thus, misuse of the data transfer function of the facsimile machine can be prevented.

According to a second aspect of the present invention, there is provided a facsimile machine connectable to PSTN and another network and adapted to receive data from a data transmitter over said another network and transfer the data to a recipient, including a memory for transfer conditions such as recipients registered in accordance with at least part of an address of the data transmitter, and a control unit for determining a recipient of data, based on the address of the data transmitter and the transfer conditions, and transferring the data to the determined recipient. If the facsimile machine receives data, the controller refers to the transfer condition memory to find out if there is a registered recipient having an address that matches the address of the data transmitter. If found, the controller then transfers the data to such recipient. Accordingly, the transmitter does not have to specify the recipient every time it sends data to the facsimile machine. Instead, the facsimile machine automatically determines an appropriate recipient and transfers the data to that recipient. Thus, operation flexibility of the facsimile machine is greatly improved.

The transfer conditions may include day and time of data transfer. Recipients may be specified by a domain name. In such a case, the data is transferred to a plurality of recipients belonging to the same domain. The recipients may include a printer of the facsimile machine and/or that connected to LAN or internet such that the data will be printed from such printer.

Additional objects, benefits and advantages of the present invention will become apparent to those skilled in the art to which the present invention pertains from the subsequent description of the embodiment and the appended claims, taken in conjunction with the accompanying drawings.

### BRIEF DESCRIPTION OF THE SEVERAL VIEWS OF THE DRAWINGS

FIG. 1 is a block diagram schematically showing a structure of facsimile machine according to the present invention;

FIG. 2 illustrates a table of deliver conditions for the facsimile machine shown in FIG. 1 to decide to which device it should transfer image data and to accept a data transfer request;

FIG. 3 illustrates a diagram of network including the facsimile machine shown in FIG. 1 connected to LAN and internet; and

FIG. 4 illustrates a flowchart of operations of the facsimile machine shown in FIG. 1 when it receives an e-mail from another device.

### DETAILED DESCRIPTION OF THE INVENTION

An embodiment of the present invention will now be described with reference to the accompanying drawings.

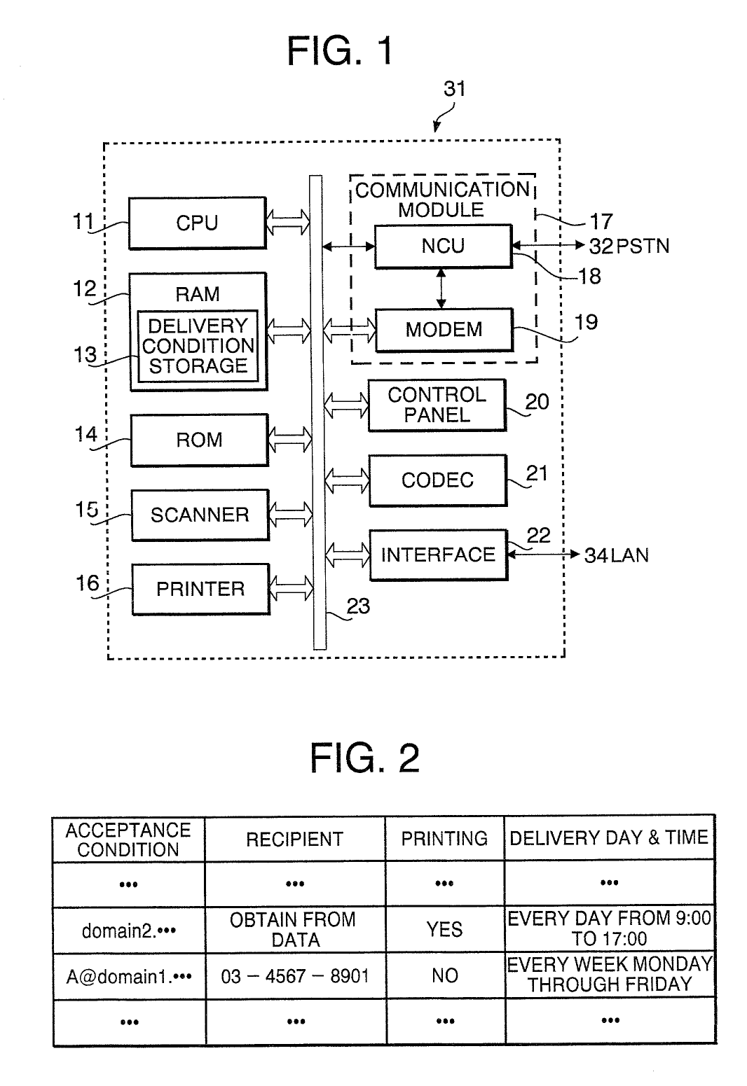

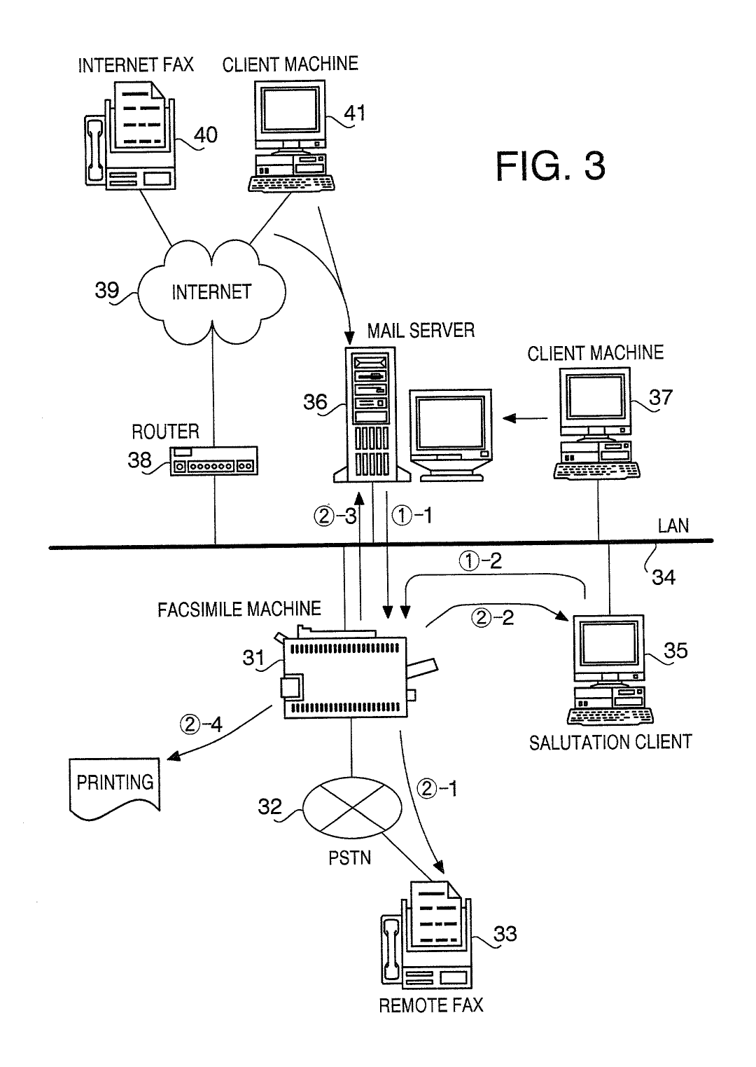

Referring to FIG. 1, illustrated is a facsimile machine 31 that includes a control unit (CPU) 11, RAM 12, a transfer condition storage 13, ROM 14, a scanner 15, a printer 16, a communication module 17, NCU 18, a modem 19, a control (or operation) panel 20, CODEC (coder-and-decoder) 21, and an interface 22. These hardware elements are connected by a bus 23. NCU 18 and modem 19 are directly connected to each other. NCU 18 is connected to PSTN 32, and the interface 22 is connected to LAN 34. A plurality of clients (FIG. 3) are connected to LAN 34.

The control unit 11 controls an overall operation of the facsimile machine 31 and causes the respective hardware elements to operate. Under the control of the main controller 11, the communication module 17 sends and receives data and information over PSTN 32, and the interface 22 sends and receives data and information to and from LAN 34. By using these functions, the facsimile machine 31 can also send data, which is received from LAN 34, to a remote facsimile machine over PSTN 32, and send data, which is received from PSTN 32, to a client on LAN 34. The facsimile machine 31 may also have other functions such as copying.

Before the main controller 11 transfers data, which is received over LAN 34, to a client on LAN 34 or to a remote device over PSTN, it refers to the transfer condition table 13 to determine whether it should send the image data to a designated recipient based on the address of a transmitting machine. Specifically, delivery information/instructions sent along with the image data from a transmitting machine is compared with the transfer conditions in the table 13. Only when the controller determines that the data transfer request is appropriate, it accepts the transfer request and transfers the data. When the controller 11 refuses the transfer request or it accepts the transfer request but the data transfer fails, it may inform the transmitting party of such fact and/or cause the printer 16 to print a message of such fact as well as the received data and information.

Information/instructions of transfer destinations may be carried together with the image data or stored in the transfer condition table 13 beforehand. In the latter case, the controller refers to the transfer condition table 13 before it transfers the data, and determines a recipient based on an address of the transmitting party. Possible recipients include a remote facsimile machine connected to PSTN 32, a client on LAN 34, a client on the internet 39 (FIG. 3). When the facsimile machine 31 transfers the data to a plurality of recipients, communication protocols suited for respective recipients are employed. It should also be noted that the printer 16 and/or another printer on LAN 34 may also be recipients.

RAM 12 stores data needed to be held for processing of various data in the main controller 11 and other hardware elements. Image data and information to be transmitted from and received at the communication module 17 and interface 22 may also be stored in RAM 12. It should be noted that another memory may be provided for storing image data and information to be transmitted and received over PSTN 32, LAN 34 and internet 39.

RAM 12 has the transfer condition storage 13. A user of the facsimile machine 31 registers various condition data in the storage 13 to determine to which recipient the data received over LAN 34 should be transferred (delivered) from the facsimile machine 31. FIG. 2 illustrates one example of transfer conditions. In this example, acceptance condition (first column), and transfer day and time (fourth column) are transfer conditions. Recipient information (second column) and necessity of printing (third column) are input in accordance with these items.

The acceptance condition may an address of a transmitter that sends data and information to the facsimile machine 31 over LAN, or part of such address. If the transmitter address is an e-mail address, a domain name may be registered in the first column in the table 13, as part of the transmitter address. In this case, data transfer requests from a plurality of transmitters having e-mail addresses that belong to the same domain as the registered one are accepted. The address registered in the first column in the table 13 may be other than e-mail address. For instance, an address in a salutation protocol or part of it may be used. Further, a plurality of transmitter addresses or part of them may be registered. In addition, additional conditions may be attached to the transmitter addresses or part of them.

The transfer day and time condition specifies day and time for data transfer. For example, the second row specifies 9:00 a.m. to 5:00 p.m., which is a general office hour, and the third row specifies Monday through Friday, which are week days. These conditions may be effective every day, every week, every month and every year, or only a particular day and week. It is also satisfactory to combine the second and third rows of the table 13. The fourth column may also specify day and time for no data transfer. Of course, it is possible not to limit the transfer day and time.

The destination (recipient) may be specified by the transfer instructions received together with the data, or registered beforehand. In the former case, the controller 11 obtains recipient information from the transfer instructions upon receiving the data from a transmitter. In the latter case, a facsimile number may be registered if the data should be transferred over PSTN, and an e-mail address or salutation user ID may be registered if the data should be transferred to a client on LAN. If a machine of a recipient is specified, IP address may be registered. Further, it is possible to register information which can identify a communication protocol suited for a particular recipient. Moreover, a group of recipients having e-mail addresses can be registered by a domain name. A plurality of recipients with different protocols can be registered. If nothing is registered in the second column, the data is not transferred to any recipients. It is substantially equivalent to refusing the data transfer request.

“PRINTING,” “YES” and “NO” in the third column of the condition table 13 indicate whether or not the received data should be printed at the recording device 16 (and/or a printer connected to LAN 34) upon data transfer to a designated recipient. Even if the printing is not requested, the data may forcibly be printed out when the facsimile machine 31 cannot deliver the image data to a designated recipient.

Preferably, the deliver condition table 13 is defined in RAM 12 at a certain place where the stored data will not be erased upon power failure.

Referring back to FIG. 1, ROM 14 stores programs needed for the main controller 11 to operate and other fixed data. It should be noted that the transfer condition table 13 may be stored in a rewritable area of ROM 14.

The scanner 15 may be an image input device such as image scanner or digital camera and is able to scan image to be transmitted or copied. The printer 16 prints information and image received at the communication module 17 or interface 22, image scanned for copy, message to a user of the facsimile machine 31, etc. on a recording sheet under the control of CPU 11. The printing may be conducted by electrophotographic technique or inkjet.

The communication module 17 sends and receives image data and other information to and from a remote facsimile machine over PSTN 32 or dedicated line. The communication module 17 may also have a dial up function that enables connection to the internet 39 via PSTN 32 so that the facsimile machine 31 can send and receive data through the internet. The communication module 17 has NCU 18 and modem 19. NCU 18 controls PSTN 32 or dedicated line for communication with a remote facsimile machine. The modem 19 modulates and demodulates data to be sent and received.

The control panel 20 includes a display to indicate various information such as messages to the user, operating conditions of the machine, and operation guidance to the user. The control panel 20 also serves as an input device for the user to input various data, numerals, information and instructions. For instance, the user may operate the control panel 20 to set the transfer conditions to be registered in the table 13 of FIG. 2.

CODEC 21 compresses image data, which is to be sent from the communication module 17 and interface 22, according to a prescribed method and elongates image data, which is received at the communication module 17 and interface 22, to an original form according to an appropriate compression method. It should be noted that this data compression and restoration may be performed by CPU 11, or by combination of CODEC 21 and CPU 11.

The interface 22 is connected to LAN 34 to send and receive various data and information over LAN 34. LAN 34 may be connected to the internet 39 such that the facsimile machine 31 can communicate with other communication devices such as facsimile machines.

The bus 23 interconnects CPU 11, RAM 12, ROM 14, scanner 15, printer 16, communication module 17 (NCU 18, modem 19), control panel 20, CODEC 21 and interface 22 to enable data communication among these hardware elements. Of course, other devices such as external memories may further be connected to the bus 23.

In the illustrated embodiment, the facsimile machine 31 has the scanner 15 and printer 16 such that it can read in image for facsimile transmission and print image and data received. However, one of the scanner and printer or both of them may be dispensed with.

Referring to FIG. 3, illustrated is a block diagram of network including the facsimile machine 31 described above. A remote facsimile 33 is connected to the facsimile machine 31 of the invention over PSTN 32. A salutation client (terminal device) 35, mail server 36, client machine 37 and router 38 are connected to LAN 34 respectively so that they can communicate with the facsimile machine 31. The internet 39 is connected to LAN 34 via the router 38. To the internet 39, connected are an internet facsimile machine 40 and internet client machine 41.

The facsimile machine 31 can send and receive facsimile data to and from the remote facsimile machine 33 over PSTN 32, and communicate with other devices over LAN 34.

A plurality of client machines such as salutation client 35 and client machine 37 are connected to LAN 34. The salutation client 35 is a client machine that can communicate with the facsimile machine 31 under the salutation protocol. In this embodiment, the client machine 37 has an e-mail function so that the facsimile machine 31 functions as a facsimile server.

The single salutation client 35 and single client machine 37 are illustrated, but they may be more than one respectively. Alternatively, one of them may be dispensed with. Likewise, a plurality of mail server 36 may be attached to LAN 34 or no mail server 36 may be provided. Further, other servers and network devices may also be connected to LAN 34.

The facsimile machine 31 may also be connected to another LAN via the router 38.

When the client machine 41 transmits an e-mail to the facsimile machine 31 together with a data transfer request as indicated by the line \mathring{1}-1, the facsimile machine 31 receives the data via the mail server 36. If the salutation client 35 transmits data to the facsimile machine 31 together with a data transfer request as indicated by the line \mathring{1}-2, the facsimile machine 31 directly receives the data.

Upon receiving the data, the facsimile machine 31 refers to the transfer condition table 13 and determines whether the data transfer request should be accepted, based on the address of the transmitter. If an e-mail address of a received e-mail is that of the client machine 37, the facsimile machine 31 accepts the transfer request. On the other hand, an e-mail is received from another domain via the internet 39, the facsimile machine 31 may refuse the transfer request. This prevents a device on other networks from misusing the facsimile machine 31. The transfer day and time may also be considered when determining acceptance and refusal of the transfer request.

If the transfer request is accepted, a recipient and necessity of printing are then obtained and checked with the transfer condition table 13. If the destination column indicates “obtain from transfer instructions” as in the second row of the table 13 in FIG. 2, the controller 11 finds out a recipient from the delivery information/instructions and transfers the data to that recipient. On the other hand, if the destination column indicates a particular recipient, who is registered beforehand, the control 11 simply uses that recipient. In the latter case, the delivery information/instructions from a transmitter do not have to include recipient information so that a transmitter is required to prepare less information to be attached to the data.

If a destination is the remote facsimile machine 33, the facsimile machine 31 transfers the data over PSTN 32 as indicated by the line \mathring{2}-1. If the destination is the salutation client 35, the facsimile machine 31 transfers the data by a salutation protocol as indicated by the line \mathring{2}-2.

If an e-mail address is registered in the destination column of the table 13, data received by SMTP is first transferred to the mail server 36 in the form of e-mail as indicated by the line \mathring{1}-3. If it belongs to the same domain, the client machine 37, for example, accesses the mail server 36 to retrieve the e-mail by POP3 protocol. If the domain name of the e-mail address is not the same, the mail server 36 transmits the e-mail to another mail server connected to the internet 39 via the router 38.

If the printing is requested, or the printing is not requested but the data transmission to a designated recipient fails, the facsimile machine 31 causes its printer 16 to print the data as indicated by the line \mathring{2}-4.

It should be noted that the data delivery destination may be more than one. Based on the delivery condition table 13, a plurality of destinations may be specified and the data may be transferred to them according to respective routes and protocols.

Prior to data transfer, the delivery conditions should be registered in the storage 13. In this embodiment, as illustrated in FIG. 2, the delivery conditions are acceptance condition, recipient, necessity of printing, and delivery day and time. These conditions may be input by a user who operates the control panel 20, or from a remote device through the communication module 17 or interface 22.

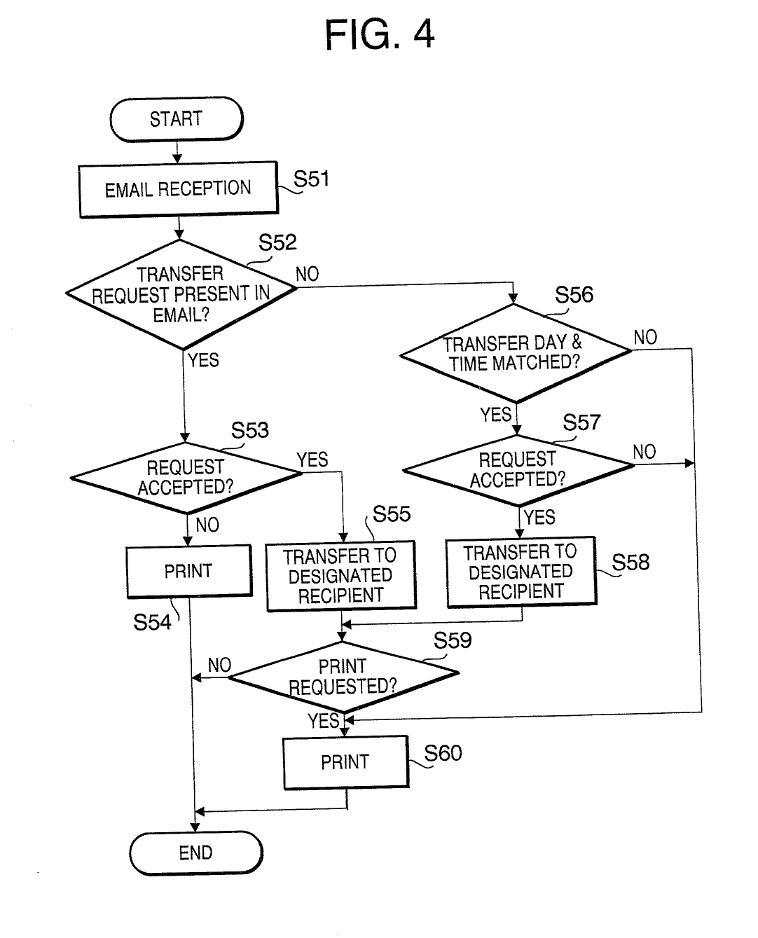

FIG. 4 illustrates a flowchart of one concrete example of procedures performed by the facsimile machine 31. It should be assumed that the delivery conditions are already registered in the table 13 and the facsimile machine 31 receives an e-mail. It should be noted that a file attached to the e-mail may be subject data to be transferred.

At S51, the facsimile machine 31 receives an e-mail. At S52, it is determined whether a data transfer request is attached to the e-mail. The transfer request may be written in an e-mail subject area or main text. If the answer at S52 is yes, the controller 11 refers to the first column of the table 13 to determine if an address of the received e-mail matches any address registered in the table 13 at S53. If there is no matching address, the transfer request is refused, and the received information is printed out from the printer 16 at S54. It is also satisfactory to notify the transmitter of “transfer not possible.” In this manner, if someone tries to misuse the facsimile machine 31, the data transfer does not proceed.

If the data transfer request is accepted, the program advances to S55 from S53, and the facsimile machine 31 transfers the data to a designated recipient. If a plurality of recipients are indicated in the e-mail, the facsimile machine 31 transfers the e-mail to these recipients using respective formats and protocols.

After the e-mail transfer, it is determined whether the printing is requested in the table 13 at S59. If yes, the controller 11 causes the printer 16 to print the received information at S60.

If the data transfer request is not included in the e-mail (No at S52), the controller 11 refers to the delivery condition table 13 to determine whether the e-mail should be transferred, according to the registered delivery conditions. First, it is determined whether the current time matches the registered day and time at S56. If it matches, it is then determined whether the address of the e-mail matches any one of the registered addresses at S57. If it matches, the controller 11 determines that this data should be transferred. Subsequent to this, a destination is obtained from the second column of the table 13 and the e-mail is transferred to that destination. This procedure is advantageous since the transmitter does not have to attach a data transfer request to the e-mail. It is particular convenient if a transmitter sends e-mails through the facsimile machine 31 frequently. This automatic data transfer occurs when, for example, there is a contract of data transfer between a transmitter and the facsimile machine 31.

After S58, the controller 11 checks whether the printing is requested at S59. If requested, the controller 11 causes the printer 16 to print the received information at S60.

If the answer at S56 is no, the program proceeds to S60, thereby printing the received information at the printer 16. Such is the case with when the answer at S57 is no.

In the above example, when the data transfer request is found in the received e-mail, the delivery day and time is not checked. However, it is satisfactory to consider the registered delivery day and time in determining whether the e-mail should be transferred. If the current time does not match the registered day and time, the e-mail may not be transferred and instead printed out from the printer 16.

It should be noted that the present invention is not limited to the above described embodiment. For example, the data to be transferred through the facsimile machine 31 is not limited to that carried with the e-mail. The manners of accepting the transfer request and the data transfer according to the present invention are applicable when the facsimile machine 31 receives data from the salutation client 35 by a salutation protocol.

What is claimed is:

1. A facsimile machine connectable to PSTN and another network and adapted to receive data from a data transmitter over the another network and transfer the data to a recipient, comprising:
a memory for storing delivery conditions, including whether or not a request for data transfer should be accepted, in accordance with at least part of an address of a data transmitter; and
a control unit for determining whether the request for data transfer should be accepted, based on the address of the data transmitter and the delivery conditions.

2. A facsimile machine connectable to PSTN and another network and adapted to receive data from a data transmitter over the another network and transfer the data to a recipient comprising:
a memory for delivery conditions including recipients registered in accordance with at least part of an address of a data transmitter; and
a control unit for determining a recipient of data, based on the address of the data transmitter and the delivery conditions, and transferring the data to the determined recipient.

3. The facsimile machine of claim 2, wherein the delivery conditions include day and time of data transfer.

4. The facsimile machine of claim 1, wherein the another network includes LAN and internet, the data is an e-mail, and the control unit accepts the request for data transfer if the e-mail is received over LAN and does not accept the request for data transfer if the e-mail is received over the internet.

5. The facsimile machine of claim 2, wherein the recipient is specified by a facsimile number or e-mail address.

6. The facsimile machine of claim 2, wherein the controller can transfer the data to a plurality of recipients.

7. The facsimile machine of claim 6, wherein the recipients are specified by facsimile numbers and e-mail addresses.

8. The facsimile machine of claim 2, wherein the recipients include a printer connected to the another network.

9. The facsimile machine of claim 1, wherein the data is printed when the request for data transfer is refused.

10. A data transfer method comprising the steps of:
A) receiving data over a network; and
B) determining whether the data should be transferred to a designated recipient based on predetermined delivery conditions and an address of a data transmitter.

11. The data transfer method of claim 10 further including the step of transferring the data to the designated recipient according to determination made in the step B.

12. The data transfer method of claim 10, wherein the predetermined delivery conditions include day and time of data transfer.

13. The data transfer method of claim 10, wherein the network includes LAN and internet, the data is an e-mail, and the step B determines that the data should be transferred if the e-mail is received over LAN and that the data should not be transferred if the e-mail is received over the internet.

14. The data transfer method of claim 10, wherein the recipient is a printer connected to the network.

15. The data transfer method of claim 10 further including the step of printing the data when the step B determines that the data should not be transferred.
